(19) United States
(12) Patent Application Publication
(10) Pub. No.: US 2024/0421540 A1
(43) Pub. Date: Dec. 19, 2024

(54) HIGH-SPEED CONNECTOR

(71) Applicant: BIZLINK INTERNATIONAL CORP., New Taipei City (TW)

(72) Inventors: Sheng Yao HUNG, New Taipei City (TW); Wenshu CHIANG, New Taipei City (TW); Chia-Hsueh LU, New Taipei City (TW)

(21) Appl. No.: 18/741,824

(22) Filed: Jun. 13, 2024

(30) Foreign Application Priority Data
Jun. 13, 2023 (CN) 202310702655.2

(51) Int. Cl. H01R 13/6585; H01R 13/502; H01R 13/518

(52) U.S. Cl. CPC H01R 13/6585; H01R 13/502; H01R 13/518

(57) ABSTRACT

The disclosure discloses an automotive connector, which includes a main body and a barrier component. A plurality of terminals are disposed in the main body. An end of each of the terminals is exposed from a bottom of the main body. The barrier component includes a partition plate and an isolation plate located on a side of the partition plate. The isolation plate is provided with the same number of through holes as terminal modules. When the partition plate is embedded in the main body, the partition plate is installed at the bottom of the main body. The through holes are used for terminals to pass through and to separate the terminals. This automotive connector can isolate each terminal module from each other by designing the partition and isolation plates, so as to avoid signal interference, significantly reduce noise, and be suitable for high-frequency scenarios.

### CROSS-REFERENCE TO RELATED APPLICATION

This application claims priority to China Application Serial Number 202310702655.2, filed Jun. 13, 2023, which is herein incorporated by reference.

### BACKGROUND

### Technical Field

The present disclosure relates to the technical field of electrical connectors, and more particularly, to a high-speed connector of which the bottom is provided with an isolation plate.

### Description of Related Art

High-speed connectors have been used in various industries. Take Rosengerber H-MTD “E6S20D-40MT5-Z”, a common high-speed connector on the market, as an example. This electrical connector is equipped with a partition plate on the main body. The partition plate is inserted between two rows of terminals to prevent the signals between the two rows of terminals from interfering with each other. However, the signals from the terminals located in the same row may cause interference, especially at high frequencies, and the noise will be obvious. It is necessary to design an electrical connector that can isolate terminal groups from each other to ensure that it can transmit signals stably at high frequencies.

In addition, most of terminals of existing connectors adopt separate assembly designs. That is, after the terminals are assembled into the insulating layer, the terminals together with the insulating layer are assembled into the conductor. However, since the structure of each terminal is “L” shaped, the insulating layer cannot completely cover the terminals and can only wrap the head portions of the terminals. At the same time, a barb structure is provided on the head portion of each terminal to prevent the terminals from separating, and the portion of each terminal are exposed. The waterproofness and high-frequency signal transmission quality of this type of automotive connectors need to be improved.

### SUMMARY

In order to overcome the shortcomings of the existing technology, the present disclosure provides a high-speed connector that can be used in various scenarios (such as vehicle scenarios). By designing partition and isolation plates, terminal modules can be isolated from each other to avoid signal interference, significantly reduce noise, and be suitable for high-frequency scenarios. In addition, the present disclosure simultaneously provides a high-speed connector that can reduce the exposed proportion of the terminals and improve the waterproof effect of the high-speed connector. At the same time, the high-speed connector can have better high-frequency characteristics and is less prone to signal interference.

In order to solve the above technical problems, the present disclosure provides a high-speed connector which includes a main body, a barrier component, and a plurality pairs of terminals. The main body includes a metal shielding base. A plurality of connection ports are disposed on the metal shielding base. A bottom of the metal shielding base is provided with a bottom opening. The barrier component includes an isolation plate provided with a plurality of through holes. Each of the terminals includes a head portion and a leg portion. The head portion of each of the terminals is located in a corresponding one of the connection ports. The leg portion of each of the terminals passes through a corresponding one of the through holes. The leg portion of each of the terminals is surrounded by any of the through holes.

According to an embodiment of the disclosure, the leg portion is provided with a terminal support. The isolation plate has a predetermined thickness. The predetermined thickness is equal to a height of the terminal support.

According to an embodiment of the disclosure, the leg portion is provided with a terminal support. The isolation plate has a predetermined thickness. A height of the terminal support is between ¾ and 4/3 of the predetermined thickness.

According to an embodiment of the disclosure, the barrier component further includes a partition plate for separating and blocking the terminals. The partition plate and the isolation plate are vertically connected to each other. The barrier component may be one piece formed.

According to an embodiment of the disclosure, the partition plate and the isolation plate may be connected in an assembled manner.

According to an embodiment of the disclosure, a material of the partition plate and a material of the isolation plate are different. The isolation plate is made of insulating material. A side of the isolation plate has a bent portion parallel to the partition plate, and two sides of the isolation plate are respectively embedded in two retaining grooves of the metal shielding base.

On the other hand, the present disclosure provides a high-speed connector which includes a plurality of terminal modules, a metal shielding base, and barrier component. Each of the terminal modules includes a pair of terminals and an insulator. Each of the terminals includes a head portion, a leg portion, and a turning portion. The insulator wraps an entirety of the turning portion. The metal shielding base has an accommodating chamber. The terminal modules are disposed in the accommodating chamber. The barrier component has a plurality of through holes. The barrier component covers at least a part of the accommodating chamber. The barrier component allows the leg portions of the plurality of terminal modules to penetrate the through holes respectively.

According to an embodiment of the disclosure, the insulator is provided with a protruding structure that is annular. The protruding structure interferes with the metal shielding base.

According to an embodiment of the disclosure, the protruding structure and the insulator may be one piece formed.

According to an embodiment of the disclosure, a material of the protruding structure and a material of the insulator are different. The protruding structure may be softer than the insulator. The protruding structure is fixed in an annular groove on the insulator.

According to an embodiment of the disclosure, the turning portion may account for more than 70% of an entire length of the each of the terminals.

According to an embodiment of the disclosure, the insulator is further provided with a protruding ring in addition to the protruding structure. The protruding ring interferes with the metal shielding base. The protruding ring and the insulator may be one piece formed.

The above is only used to describe the problems to be solved by the present disclosure, technical solutions to solve the problems and their effects, and so on. Specific details of the present disclosure will be described in the following embodiments with reference to relevant drawings.

### BRIEF DESCRIPTION OF THE DRAWINGS

In order to make the above and other purposes, features, advantages, and embodiments of the present disclosure easier to understand, the accompanying drawings are provided and described as follows.

FIG. 1 is a schematic diagram of an overall assembly of the present disclosure;

FIG. 2 is a schematic diagram of the assembly of the present disclosure from another angle;

FIG. 3 is a schematic diagram of a metal shielding base of the present disclosure;

FIG. 4 is a schematic diagram of the metal shielding base of the present disclosure from another angle;

FIG. 5 is a schematic diagram of a connector of the present disclosure with a plastic housing removed;

FIG. 6 is a cross-sectional view taken along line A-A in FIG. 3;

FIG. 7 is a schematic diagram of a barrier component in the present disclosure;

FIG. 8 is a schematic diagram of a terminal module in the present disclosure;

FIG. 9 is a partial structural diagram of the terminal module in the present disclosure;

FIG. 10 is a schematic diagram of a terminal in the present disclosure; and

FIG. 11 is a graph of signal scattering intensity-frequency curves of an automotive connector of the present disclosure and an existing connector.

### DETAILED DESCRIPTION

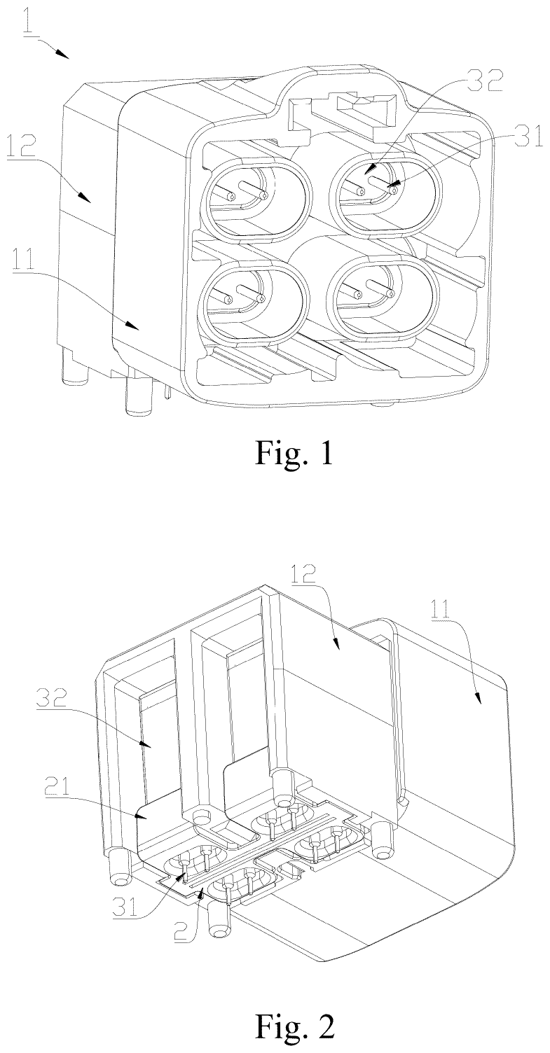

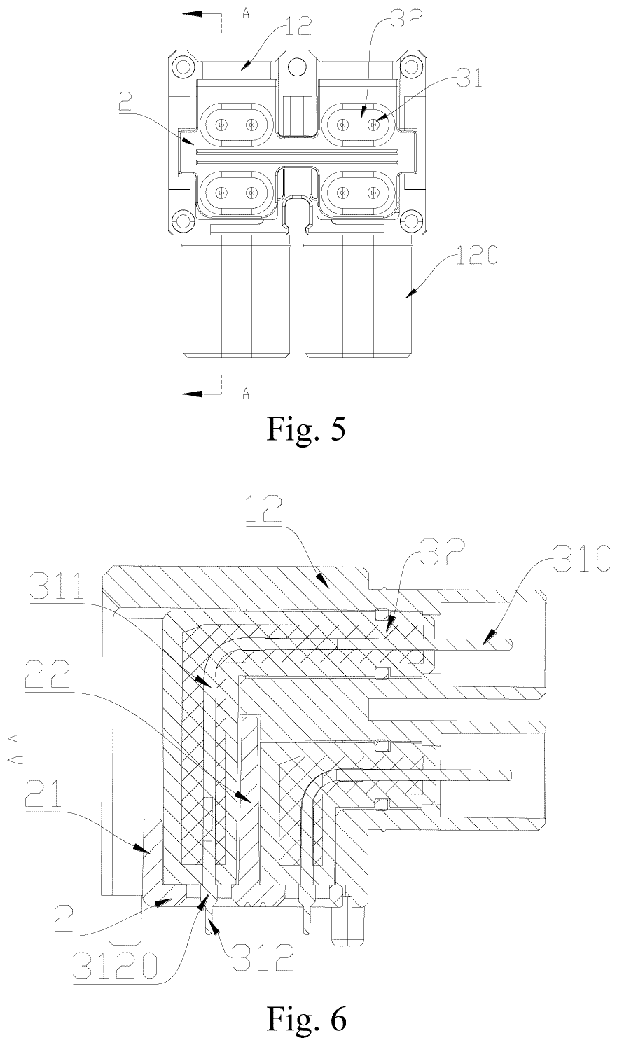

The following will clearly and completely describe the concept, specific structure and technical effects of the present disclosure in conjunction with the embodiments and drawings to fully understand the purpose, features and effects of the present disclosure. Obviously, the described embodiments are only some of the embodiments of the present disclosure, not all embodiments. Based on the embodiments of the present disclosure, other embodiments obtained by those skilled in the art without exerting creative efforts shall fall within the scope of protection of the present disclosure. In addition, all the connection relationships involved in the disclosure do not only refer to the direct connection of components, but refer to the fact that a better connection structure can be formed by adding or reducing connection auxiliary parts according to the specific implementation conditions. Various technical features in the invention can be combined interactively without conflicting with each other. In addition, the drawings of FIGS. 1 to 10 are drawn to true scale. In order to keep the description concise, the proportions of each component are not listed one by one, but the proportions and positions of each component should be regarded as part of the content of this description. Furthermore, if the description in the disclosure is not enough to explain the detailed design of the component and cannot be implemented, please refer to the design of Rosengerber H-MTD “E6S20D-40MT5-Z” connector as a reference.

As shown in FIGS. 1 to 4, the present disclosure provides a high-speed connector, which can be applied in the field of automotive connectors, for example. In the present embodiment, the high-speed connector is a board-end connector. However, in other embodiments, it can also be modified into a wire-end connector by welding a cable at an end of terminals. In the present embodiment, the high-speed connector is mainly composed of a main body 1, a barrier component 2, and four terminal modules 3.

As shown in FIGS. 1 to 4, in the present embodiment, the main body 1 is composed of a plastic housing 11 and a metal shielding base 12. The plastic housing 11 is an insulating hollow structure and is sleeved on an outer periphery of connection ports 1221. The plastic housing 11 is provided with a positioning protrusion with a wide head and a narrow body (not shown in the figure). The metal shielding base 12 is correspondingly provided with a C-shaped positioning groove (not shown in the figure). The plastic housing 11 and the metal shielding base 12 are connected together through the cooperation of the positioning protrusion and the positioning groove. As shown in FIG. 1, a rectangular space is provided at the upper center of a front end surface of the plastic housing 11 for buckling and accommodating external connectors.

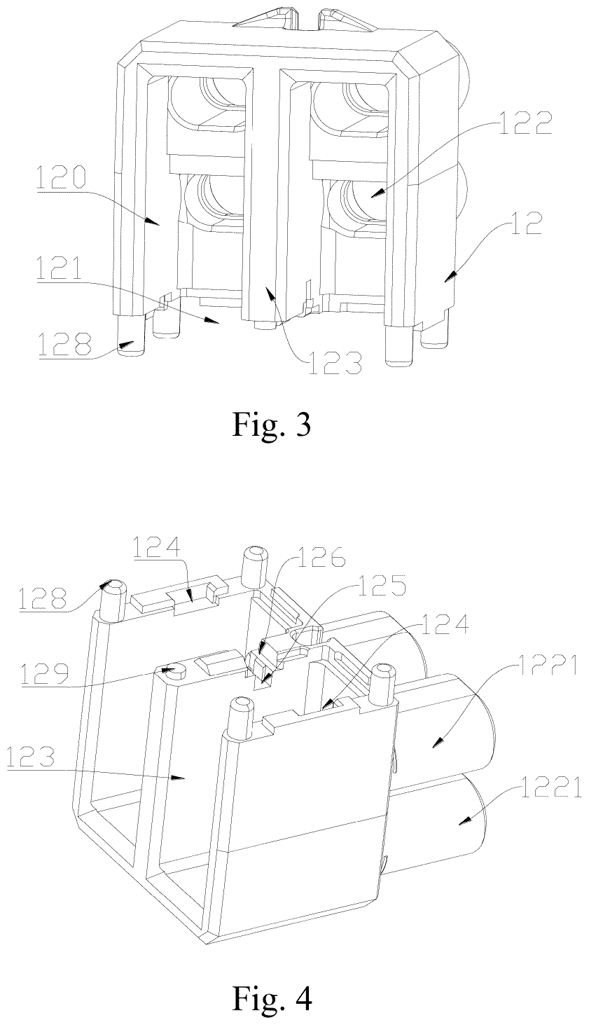

As shown in FIGS. 3 and 4, the metal shielding base 12 is one piece formed of metal material. The metal shielding base 12 is generally a hollow square cylinder, with a plurality of first pins 128 provided at the bottom for grounding with a circuit board. The hollow portion in the metal shielding base 12 is called accommodating chamber. The accommodation cavity is divided into two installation cavities arranged on the left and right by a wall plate 123 in the middle. Each of the installation cavities is provided with a first opening 120 (rear opening), a second opening 121 (bottom opening), and two third openings 122 (front openings) arranged up and down.

A front end surface of the metal shielding base 12 is provided with two sets of connection ports 1221 arranged up and down and arranged in a row. The number of the connection ports 1221 is four. Each of the connection ports 1221 is in the shape of a hollow circular tube. Taking FIG. 3 as an example, each of the third openings 122 is defined by a connection port 1221. In addition, as shown in FIG. 6, it can be seen from the figure that in order to accommodate the terminal modules 3 of different shapes for insertion, the depth of the upper row of the third openings 122 is larger than the depth of the lower row of the third openings 122.

As shown in FIGS. 3 and 4, first retaining grooves 124 are provided on both sides of the second opening 121 of the metal shielding base 12. A second retaining groove 125 is provided in the middle of a lower end surface of the wall plate 123. Retaining steps 126 are provided on both sides of the second retaining groove 125. An end of the wall plate 123 is provided with a second pin 129 for grounding. The first pins 128 are longer than the second pin 129.

As shown in FIGS. 3 and 6, the four connection ports 1221 provided in the metal shielding base 12 are divided into a left row and a right row. When the terminal modules 3 are assembled into the connection ports 1221, the terminal modules 3 in different installation cavities are isolated by the wall plate 123.

As shown in FIGS. 8 and 10, each of the terminal modules 3 includes a differential terminal pair for transmitting electrical signals, that is, it includes two parallel metal terminals 31 and an insulator 32 wrapped around the periphery of the terminals 31. In the present embodiment, each of the terminals 31 is a cylindrical pin bent into an L-shaped shape.

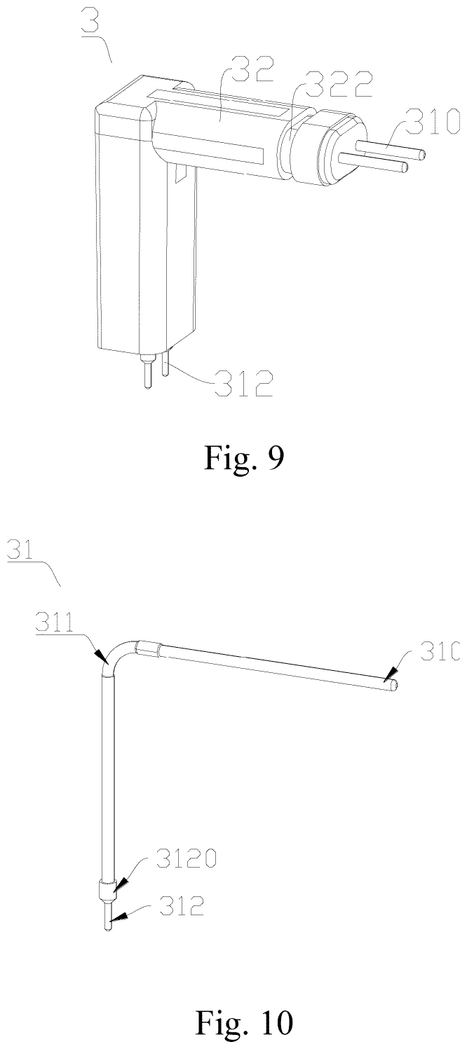

As shown in FIG. 10, each of the terminals 31 includes a head portion 310, a turning portion 311, and a leg portion 312. One end of the leg portion 312 is provided with a terminal support 3120 with a larger cross-sectional area. The turning portion 311 accounts for more than 70% of an entire length of the terminal 31. As shown in FIG. 9, the insulator 32 wraps the turning portion 311 of the terminal 31 and exposes the head portion 310 and the leg portion 312. The insulator 32 is formed outside the terminal 31 through an injection molding process. Compared with a conventional separate assembly structure, the insulator 32 in the present disclosure covers a larger proportion of the terminal 31. Except for an end of the head portion 310 and an end of the leg portion 312 of the terminal 31, the rest portions are covered by the insulator 32, which ensures that the connector has good waterproof effect and its signal transmission quality is also better.

As shown in FIGS. 8 and 9, the insulator 32 is generally L-shaped. For example, the upper part of the insulator 32 in FIG. 9 has a horizontal extending arm, and at least one annular groove 322 is provided in the middle part of the extending arm. An protruding structure 321 that is annular is provided in the annular groove 322. In the present embodiment, the protruding structure 321 is directly formed in the annular groove 322 through a secondary injection process, that is, the protruding structure 321 and the insulator 32 are one piece formed. The insulator 32 and the protruding structure 321 are made of different materials, and the material of the protruding structure 321 is softer than the material of the insulator 32. However, in another embodiment, the protruding structure 321 may be a waterproof gasket (such as an O-ring). With this design, when the terminal module 3 is assembled into the accommodating chamber of the metal shielding base 12, the soft material of the protruding structure 321 can undergo a certain degree of elastic deformation to fill the space between the terminal module 3 and the accommodating chamber. In this way, in addition to further improving the waterproof effect, the interference between the protruding structure 321 and the metal shielding base 12 can also fix the two to each other. In addition, in another embodiment, the insulator 32 may also be another protruding ring (not shown) one piece formed behind the protruding structure 321. The aforementioned protruding ring and the insulator 32 are one piece formed to further interfere with the metal shielding base 12 to make the two more stable.

As shown in FIG. 10, the terminal support 3120 with the larger cross-sectional area is provided on an edge of the leg portion 312 and the turning portion 311. A bottom surface of the terminal support 3120 is substantially flush with an end surface of the insulator 32. In addition, an isolation plate 23 has a predetermined thickness T. The terminal support 3120 provided at the leg portion 312 has a height h. When the predetermined thickness T is equal to the height h, or the height h is between ¾ of the predetermined thickness T and 4/3 of the predetermined thickness T, a better signal isolation effect can be achieved. Taking into account tolerances, when the dimensions of the larger of A and B (such as height, thickness, etc.) are 100 to 105% of the size of the smaller, the dimensions of A and B are said to be the same.

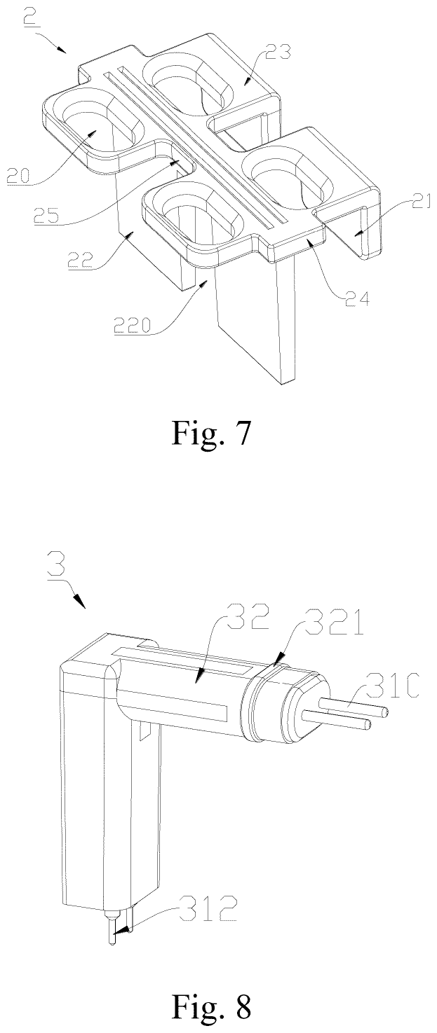

In addition, as shown in FIG. 7, the barrier component 2 is generally T-shaped and includes a partition plate 22 and the isolation plate 23 disposed perpendicularly to each other. In the present embodiment, the partition plate 22 and the isolation plate 23 are on piece molded and cast from metal materials. However, in another embodiment, the partition plate 22 and the isolation plate 23 can also adopt a combined design and can be selectively made of different materials. For example, as shown in FIG. 7, the vertically disposed partition plate 22 is made of metal, while the horizontally disposed isolation plate 23 may optionally be made of insulating plastic material. When the isolation plate 23 is made of plastic material, the isolation plate 23 is manufactured using the embedded injection molding process. The isolation plate 23 made of plastic material has an appropriate dielectric coefficient, which can effectively block signal interference and improve high-frequency characteristics.

As shown in FIG. 7, the isolation plate 23 is disposed on a side of the partition plate 22 away from a notch 220 and is perpendicular to the partition plate 22. When the partition plate 22 is embedded in the wall plate, the isolation plate 23 is positioned at the bottom of the main body 1, that is, at the second opening 121 of the metal shielding base 12.

Recessed structures 25 are provided on both sides of middle portion of the isolation plate 23. The recessed structure 25 divides the isolation plate 23 into four areas. A distance between the recessed structure 25 and the partition plate 22 is equal to a height of a retaining step 126. A distance between the notch 220 and the isolation plate 23 is equal to a height of the second retaining groove 125. Through the first retaining grooves 124, the retaining step 126, and the second retaining groove 125, the barrier component 2 and the main body 1 can be fixedly connected. The barrier component 2 will not fall off when decorated on the bottom of the main body 1. That is, both sides of the isolation plate 23 are respectively embedded in the first retaining grooves 124 and the second retaining groove 125 of the metal shielding base 12 for fixation.

A through hole 20 is provided in each of the four divided areas of the isolation plate 23. Each through hole 20 is a left-right symmetrical waist-shaped structure. The through holes 20 in the four areas correspond to the leg portions 312 of the four terminal modules 3. Each through hole 20 is slightly smaller than an end surface area of the insulator 32 of the terminal modules 3 and only allows the end of the leg portion 312 to pass through. The four areas of the isolation plate 23 can separate the differential pairs in the four terminal modules 3 one by one, thereby improving signal quality.

As shown in FIGS. 6 and 7, the isolation plate 23 may also be optionally provided with a bent portion 21. The bent portion 21 is substantially parallel to the partition plate 22 and is used to limit the position of the outer terminal modules 3, prevent them from falling out of the first opening 120 (rear opening), and reduce the possibility of incorrect assembly. The main part of the bent portion 21 is located in the accommodating chamber of the metal shielding base 12. In addition, as shown in FIG. 7, it can be seen that the middle portion of the vertically disposed partition plate 22 is provided with the notch 220. The size of the notch 220 is consistent with the thickness of the wall plate 123. The notch 220 of the partition plate 22 is embedded in the wall plate 123 to isolate signal interference between terminal modules 3 in different rows.

Each of the connection ports 1221 is provided with one of the terminal modules 3. The terminal modules 3 are inserted into the connection ports 1221 at the end of the third openings 122 along the first opening 120 and the second opening 121. The head portions of the terminal modules 3 are inserted into the connection ports 1221 of the metal shielding base 12. The leg portions 312 of the terminal module 3 are exposed to the outside of the second opening of the metal shielding base 12. The outer peripheral contour of the insulator 32 is in an arc shape, which can facilitate the insertion of the terminal modules 3 into the connection ports 1221.

The assembly steps of the automotive connector are as follows. First, the insulator 32 and the terminals 31 are injection molded to form each of the terminal modules 3. Next, the terminal modules 3 are inserted into the connection ports 1221 along the first opening 120 and the second opening 121 of the metal shielding base 12. Finally, the barrier component 2 is inserted at the second opening 121. The bent portion 21 is located on a side of the terminal modules 3 facing the first opening 120 and can retain the terminal modules 3 to prevent loosening.

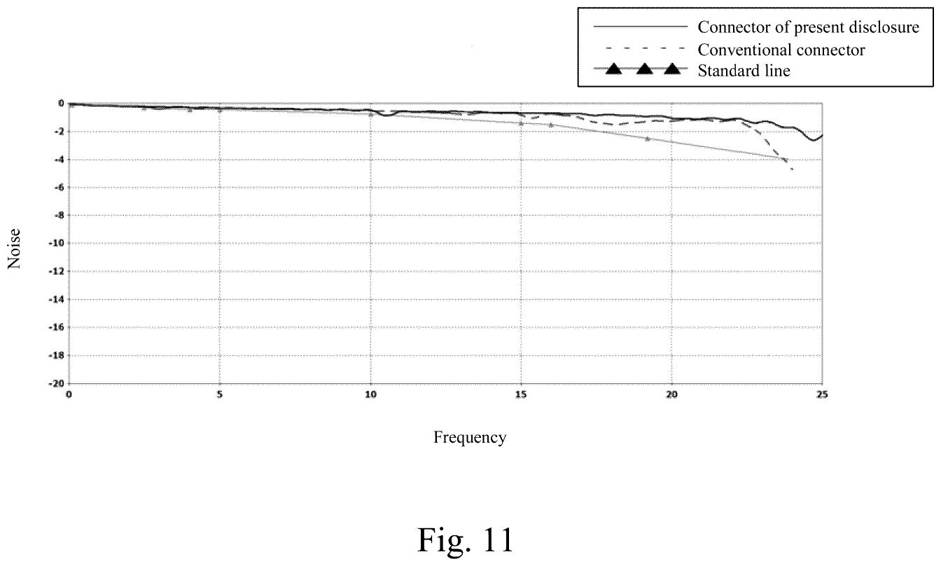

As shown in FIG. 11, after experimental testing, when reaching the 24G frequency band, the noise of a conventional electrical connector has exceeded the standard line, but the electrical connector of the present disclosure can maintain the level of −2 db. The signal isolation effect of the electrical connector of the present disclosure is significantly better than that of the conventional electrical connector.

The above is a detailed description of the preferred embodiments of the present disclosure, but the present disclosure is not limited to the embodiments. Those skilled in the art can also make various equivalent modifications or substitutions without departing from the spirit of the disclosure. These equivalent modifications or substitutions are included within the scope defined by the claims of this disclosure.

What is claimed is:

1. A high-speed connector, comprising:
a main body comprising a metal shielding base, a plurality of connection ports being disposed on the metal shielding base, a bottom of the metal shielding base being provided with a bottom opening;
a barrier component comprising an isolation plate provided with a plurality of through holes; and
a plurality pairs of terminals, each of the terminals comprising a head portion and a leg portion, the head portion of each of the terminals being located in a corresponding one of the connection ports, the leg portion of each of the terminals passing through a corresponding one of the through holes and the leg portion of each of the terminals being surrounded by any of the through holes.

2. The high-speed connector of claim 1, wherein the leg portion is provided with a terminal support, the isolation plate has a predetermined thickness, and the predetermined thickness is equal to a height of the terminal support.

3. The high-speed connector of claim 1, wherein the leg portion is provided with a terminal support, the isolation plate has a predetermined thickness, and a height of the terminal support is between ¾ and 4/3 of the predetermined thickness.

4. The high-speed connector of claim 3, wherein the barrier component further comprises a partition plate for separating and blocking the terminals, and the partition plate and the isolation plate are vertically connected to each other.

5. The high-speed connector of claim 4, wherein the barrier component is one piece formed.

6. The high-speed connector of claim 4, wherein the partition plate and the isolation plate are connected in an assembled manner.

7. The high-speed connector of claim 6, wherein a material of the partition plate and a material of the isolation plate are different.

8. The high-speed connector of claim 7, wherein the isolation plate is made of insulating material.

9. The high-speed connector of claim 4, wherein a side of the isolation plate has a bent portion parallel to the partition plate.

10. The high-speed connector of claim 1, wherein two sides of the isolation plate are respectively embedded in two retaining grooves of the metal shielding base.

11. A high-speed connector, comprising:
a plurality of terminal modules, each of the terminal modules comprising a pair of terminals and an insulator, wherein each of the terminals comprises a head portion, a leg portion, and a turning portion, and the insulator wraps an entirety of the turning portion;
a metal shielding base having an accommodating chamber, wherein the terminal modules are disposed in the accommodating chamber; and
a barrier component having a plurality of through holes, the barrier component covering at least a part of the accommodating chamber, the barrier component allowing the leg portions of the plurality of terminal modules to penetrate the through holes respectively.

12. The high-speed connector of claim 11, wherein the insulator is provided with a protruding structure that is annular, and the protruding structure interferes with the metal shielding base.

13. The high-speed connector of claim 12, wherein the protruding structure and the insulator are one piece formed.

14. The high-speed connector of claim 12, wherein a material of the protruding structure and a material of the insulator are different, and the protruding structure is softer than the insulator.

15. The high-speed connector of claim 14, wherein the protruding structure is fixed in an annular groove on the insulator.

16. The high-speed connector of claim 11, wherein the turning portion accounts for more than 70% of an entire length of the each of the terminals.

17. The high-speed connector of claim 12, wherein the insulator is further provided with a protruding ring in addition to the protruding structure, and the protruding ring interferes with the metal shielding base.

18. The high-speed connector of claim 17, wherein the protruding ring and the insulator are one piece formed.
